(19) United States
(12) Patent Application Publication
(10) Pub. No.: US 2010/0054377 A1
(43) Pub. Date: Mar. 4, 2010

(54) SYSTEMS AND METHODS FOR SPURIOUS SIGNAL REDUCTION IN MULTI-MODE DIGITAL NAVIGATION RECEIVERS

(75) Inventor: Dave Havener, Olathe, KS (US)

Correspondence Address: HONEYWELL/FOGG;Patent Services, 101 Columbia Road, P.O Box 2245, Morristown, NJ, 07962-2245, US

(73) Assignee: Honeywell International Inc., Morristown, NJ (US)

(21) Appl. No.: 12/200,550

(22) Filed: Aug. 28, 2008

(51) Int. Cl. H04L 27/06

(52) U.S. Cl. 375/344

(57) ABSTRACT

Systems and methods for reducing spurious signals in digital receivers. A system includes a digital navigation receiver having a controllable reference oscillator configured to generate a reference frequency based on a control signal input and a control signal generator in signal communication with the controllable reference oscillator. The control signal generator is configured to generate a waveform that sweeps in frequency such that the reference frequency is based on the waveform. A triangular waveform that sweeps in frequency is used in an example embodiment. A method includes generating a waveform that sweeps in frequency and controlling the reference oscillator based on the waveform.

### BACKGROUND OF THE INVENTION

In digital receiver designs such as those that incorporate a base band zero Hertz intermediate frequency (IF) with quadrature components, an undesirable spurious amplitude modulation (AM) caused by offset errors between in phase (I) and quadrature (Q) components of the IF is sometimes added to a received signal. The frequency of this spurious AM is typically equal to a difference between a received carrier signal frequency and a center frequency of the IF. When the receiver is used for receiving localizer signals, an error in localizer navigation can occur when the received signal carrier is offset in frequency equal to either of the localizer signal navigation tones, which are typically 90 Hertz (Hz) and 150 Hz modulation frequencies on carrier frequencies that range from 108.10 megahertz (MHz) to 111.95 MHz. When receiving VHF Omni-directional Radio Range (VOR) signals, error in VOR bearing can occur when the spurious AM falls at the same frequency as a baseband 30 Hz AM tone of the VOR signal.

### SUMMARY OF THE INVENTION

The present invention includes systems and methods for reducing spurious signals in digital receivers.

In accordance with some aspects of the invention, a system includes a digital navigation receiver having a controllable reference oscillator configured to generate a reference frequency based on a control signal input and a control signal generator in signal communication with the controllable reference oscillator. The control signal generator is configured to generate a waveform that sweeps in frequency such that the reference frequency is based on the waveform. In an example embodiment, the frequency of the reference oscillator is controlled by a control voltage at its control signal input. The control voltage sweeps up and down at a variable rate based on the waveform generated by the control signal generator.

In accordance with other aspects of the invention, the waveform is a triangular waveform that sweeps in frequency.

In accordance with still further aspects of the invention, the navigation receiver includes a signal detection component having a signal decoding response rate and the waveform has a repetition rate that is faster than the signal decoding response rate.

In accordance with yet other aspects of the invention, a method for reducing spurious signals in a multi-mode digital navigation receiver having a controllable reference oscillator includes generating a waveform that sweeps in frequency and controlling the reference oscillator based on the waveform.

In accordance with still another aspect of the invention, generating a waveform includes generating a triangular waveform that sweeps in frequency and produces a modulation index of between approximately 7.3 and approximately 12.5 at a local oscillator (LO) in signal communication with the reference oscillator.

### BRIEF DESCRIPTION OF THE DRAWINGS

Preferred and alternative embodiments of the present invention are described in detail below with reference to the following drawings:

FIG. 1 is a diagram showing a spurious signal reduction system formed in accordance with an example embodiment of the invention;

FIG. 2 is a flowchart of a method of reducing spurious signals in accordance with an example embodiment of the invention; and

FIG. 3 is a diagram showing an example signal waveform for controlling an oscillator frequency in accordance with an example embodiment of the invention.

### DETAILED DESCRIPTION OF THE INVENTION

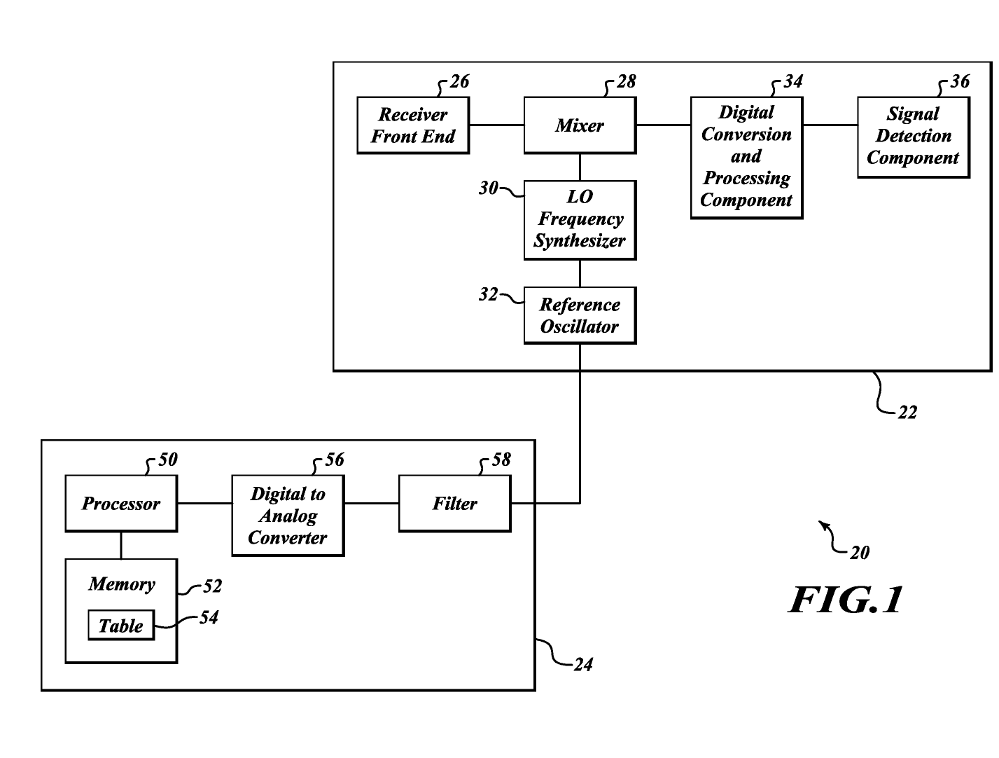

FIG. 1 is a diagram showing a spurious signal reduction system 20 formed in accordance with an example embodiment of the invention. The system 20 includes a multi-mode digital navigation receiver 22 in signal communication with a control signal generator 24. Although a multi-mode receiver is shown and described, non-multi-mode digital receivers may also be used. The digital navigation receiver 22 is a base band I/Q digital receiver in an example embodiment, but other types of receivers may also be used. In an example embodiment, the receiver 22 is configured to receive and detect localizer and VOR signals and includes a front end 26 for receiving radiofrequency (RF) signals and performing typical front end amplification and filtering functions to generate a received signal. A mixer 28 is in signal communication with the front end 26 and a local oscillator (LO) frequency synthesizer 30. A voltage controlled reference oscillator 32 having a control signal input is in signal communication with the LO frequency synthesizer 30 and generates a reference signal based on the control signal input. The LO frequency synthesizer 30 generates an LO signal based on the reference signal. The mixer 28 generates an IF signal based on the received signal and the LO signal. A digital conversion and processing component 34 is in signal communication with the mixer 28. Although a single link is shown between the mixer 28 and the digital conversion and processing component 34, it should be understood that both I and Q quadrature components may be generated by the mixer 28 and provided to the digital conversion and processing component 34. The digital conversion and processing component 34 generates a base band complex IF signal based on the IF signal from the mixer 28. A signal detection component 36 is in signal communication with the digital conversion and processing component 34 and is configured to demodulate the base band complex IF signal. In an example embodiment, the signal detection component 36 detects and demodulates AM localizer and VOR signals. In an example embodiment, the signal detection component 36 is configured as an RF envelope detector. However, the signal detection component 36 may be configured to use AM detection of quadrature base band signals or other types of signal detection in other embodiments.

In an example embodiment, the control signal generator 24 is in signal communication with the control signal input of the voltage controlled reference oscillator 32 and generates an analog voltage waveform control signal that is provided to the control signal input. The control signal generator 24 includes a processor 50 in data communication with a memory 52. The memory 52 may include non-volatile and/or volatile memory. The memory 52 may include processing instructions for the processor 50 and includes a lookup table 54 in an example embodiment. A digital to analog (D/A) converter 56 is in signal communication with the processor 50. The D/A converter 56 converts a digital waveform generated by the processor 50 to an analog waveform. A filter 58 is in signal communication with the D/A converter 56. The filter 58 is configured to filter the analog waveform from the D/A converter 56 and provide a filtered analog voltage waveform to the reference oscillator 32 in an example embodiment. The amplitude of the analog voltage waveform controls a frequency variation of the reference oscillator 32. The filter 58 is configured to remove spikes that could cause spurious response generation. However, in some embodiments, the filter 58 may not be present with the analog voltage waveform from the D/A converter 56 being directly provided to the reference oscillator 32 in an unfiltered form.

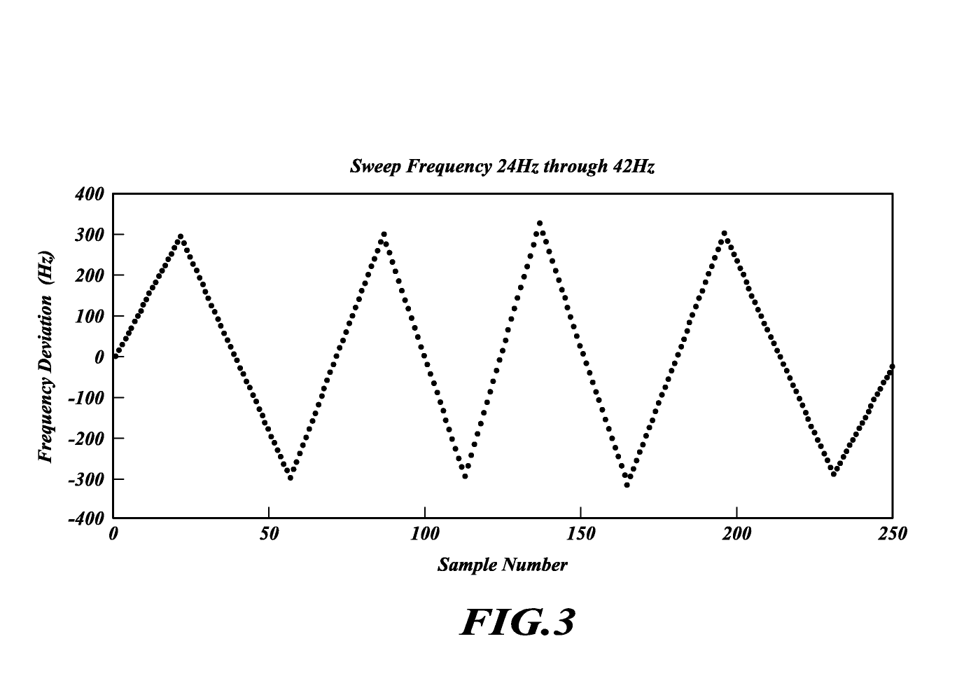

In an example embodiment, the control signal generator 24 is configured to generate a waveform that sweeps in frequency. The processor 50 is configured to generate a digital waveform, such as the triangular waveform shown in FIG. 3 based on values previously stored in the lookup table 54. The digital waveform is typically a predetermined waveform and is not based on feedback from the receiver 22 or feedback from other components of the control signal generator 24. A repetition rate of the waveform generated by the processor 50 is faster than a signal decoding response rate of the signal detection component 36, in some example embodiments. The repetition rate is approximately 8 Hz in an example embodiment where the signal detection component 36 has a decoding response rate slower than 8 Hz In this example embodiment, spurious signals are reduced by approximately a minimum of 13 dB when detecting localizer and VOR signals in comparison to a typical receiver operating with a constant reference frequency. However, different levels of spurious signal reduction may be achieved in other embodiments.

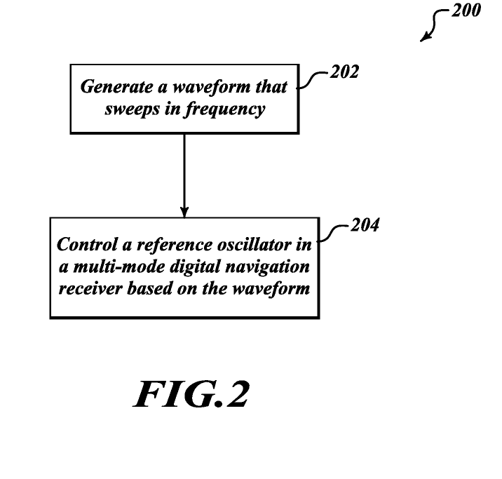

FIG. 2 is a flowchart of a method 200 of reducing spurious signals in accordance with an example embodiment of the invention. First, at a block 202, a waveform that sweeps in frequency is generated. A sweeping triangular waveform, such as the waveform shown in FIG. 3 may be generated as a digital waveform by the processor 50 based on values previously stored in the look-up table 54 followed by conversion to an analog waveform at the D/A converter 56, for example. Then, at a block 204, a reference oscillator in a multi-mode digital navigation receiver is controlled based on the waveform. The reference oscillator may be similar to the reference oscillator 32 in the receiver 22 shown in FIG. 1, for example. In an example embodiment, the repetition rate of the waveform generated at the block 202 is faster than a signal decoding response rate in a detection component of the receiver, such as the signal detection component 36, in some example embodiments. The repetition rate is approximately 8 Hz in an example embodiment where the signal detection component 36 has a decoding response rate slower than 8 Hz. Generally, spurious signals are reduced by spreading the spurious signals greater than a bandwidth of tone detection filters in the receiver 22. In an example embodiment, tone detection filters approximately 2 to 3 Hz wide are used in the signal detection component 36 to recover 90 and 150 Hz localizer signals.

FIG. 3 is a diagram showing an example signal waveform for controlling an oscillator frequency in accordance with an example embodiment of the invention. The waveform is a digital waveform generated at 2000 samples per second. The example signal waveform is a triangular waveform that sweeps in frequency from approximately 24 Hz to approximately 42 Hz with an amplitude that produces a peak frequency deviation of approximately ±300 Hz. The voltage controlled reference oscillator 32 generates a reference signal based on the waveform. The LO frequency synthesizer 30 exhibits a modulation index between approximately 7.3 and approximately 12.5 based on the reference signal. Although a triangular waveform is shown and described, truly random, pseudorandom, or other types of waveforms may be used in other embodiments. A LO frequency synthesizer exhibiting a modulation index between 7.3 and 12.5 maintains fairly even modulation sideband levels below 10 dB for a given modulation frequency. Sweeping the modulation frequency with a triangular waveform further reduces the sideband levels because the sidebands are moved and fall for a shorter period of time on any particular signal, resulting in less chance that the sideband will fall on a desired tone signal. A modulation index having a different value may be used in other embodiments, but will generally be bounded by system and response constraints such as the bandwidth of a phase lock loop contained within the LO frequency synthesizer 30 employed in the system 20 on the high side or a recovered signal response on the low side, for example.

While the preferred embodiment of the invention has been illustrated and described, as noted above, many changes can be made without departing from the spirit and scope of the invention. For example, other types of receivers having controllable oscillators may be driven by the control signal generator. Additionally, although a receiver having a base band zero hertz IF is preferably used as the receiver 22, other types of receivers may also be used. Other control signal frequency ranges, amplitudes, and/or frequency deviations may also be used in some embodiments. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A system for reducing spurious signals in digital navigation receivers, the system comprising:
a digital navigation receiver having a controllable reference oscillator configured to generate a reference frequency based on a control signal input; and
a control signal generator in signal communication with the controllable reference oscillator,
wherein the control signal generator is configured to generate a waveform that sweeps in frequency and wherein the reference frequency is based on the waveform.

2. The system of claim 1, further comprising a local oscillator (LO) frequency synthesizer in signal communication with the controllable reference oscillator, wherein the LO frequency synthesizer is configured to generate an LO signal based on the reference frequency, and wherein the LO frequency synthesizer exhibits a modulation index of between approximately 7.3 and approximately 12.5.

3. The system of claim 1, wherein the waveform is a triangular waveform that sweeps in frequency.

4. The system of claim 3, wherein the triangular waveform sweeps in frequency from approximately 24 Hertz to approximately 41 Hertz.

5. The system of claim 3, wherein the triangular waveform has an amplitude that is set to produce a peak frequency deviation of approximately ±300 Hertz.

6. The system of claim 1, wherein the navigation receiver includes a signal detection component having a signal decoding response rate, and wherein the waveform has a repetition rate that is faster than the signal decoding response rate.

7. The system of claim 6, wherein the repetition rate is approximately 8 Hertz.

8. The system of claim 1, wherein the controllable reference oscillator is a voltage controlled oscillator and the control signal generator produces an analog voltage waveform.

9. The system of claim 8, wherein the control signal generator comprises:
a processor configured to generate a digital waveform; and
a digital to analog converter in signal communication with the processor,
wherein the digital to analog converter is configured to convert the digital waveform generated by the processor to a frequency control voltage.

10. The system of claim 9, further comprising a memory unit containing a lookup table in data communication with the processor, wherein the processor is configured to generate the digital waveform based on values previously stored in the lookup table.

11. A method for reducing spurious signals in a digital navigation receiver having a controllable reference oscillator, the method comprising:
generating a waveform that sweeps in frequency; and
controlling the reference oscillator to generate a reference frequency based on the waveform.

12. The method of claim 11, wherein generating a waveform comprises generating a triangular waveform that sweeps in frequency.

13. The method of claim 12, further comprising generating a local oscillator signal having a modulation index of between approximately 7.3 and approximately 12.5 based on the reference frequency.

14. The method of claim 12, wherein generating a triangular waveform comprises generating a triangular waveform having triangular frequency components that sweep from approximately 24 Hertz to approximately 41 Hertz.

15. The method of claim 12, wherein generating a triangular waveform comprises generating a triangular waveform having an amplitude that produces a peak frequency deviation of approximately ±300 Hertz.

16. The method of claim 11, wherein generating a waveform includes generating a waveform having a repetition rate that is faster than a signal decoding response rate in a signal detection component of the receiver.

17. The method of claim 16, wherein the repetition rate is approximately 8 Hertz.

18. The method of claim 11, wherein generating a waveform includes generating an analog voltage waveform.

19. The method of claim 18, wherein generating an analog voltage waveform comprises:
generating a digital waveform; and
converting the digital waveform to an analog waveform.

20. The method of claim 19, wherein generating a digital waveform comprises generating a digital waveform based on values previously stored in a lookup table.
